(19) United States
(12) Patent Application Publication
(10) Pub. No.: US 2025/0379926 A1
(43) Pub. Date: Dec. 11, 2025

(54) METHOD AND DEVICE FOR SPEEDING UP PACKET PROCESSING

(71) Applicant: MEDIATEK INC., Hsinchu City (TW)

(72) Inventors: Hsin-Hao HUANG, Hsinchu City (TW); Chia-Chi HSIAO, Hsinchu City (TW)

(21) Appl. No.: 18/735,913

(22) Filed: Jun. 6, 2024

(51) Int. Cl. H04L 69/323; H04L 5/00; H04L 69/22; H04L 69/321; H04W 28/06

(52) U.S. Cl. CPC H04L 69/323; H04L 5/0053; H04L 69/22; H04L 69/321; H04W 28/06

(57) ABSTRACT

A method for speeding up packet processing is provided. The method is implemented by a hardware acceleration circuitry of a computing device and includes receiving uplink packets from an upper layer. The method includes performing a MAC process on the downlink TB to obtain MAC SDUs. The method includes performing a PDCP process on PDCP SDUs corresponding to the uplink packets to obtain PDCP PDUs. The method includes perform an RLC process on RLC SDUs corresponding to the PDCP PDUs to obtain RLC PDUs. The method includes performing a MAC process on MAC SDUs corresponding to the RLC PDUs to obtain a TB. The method includes transmitting the TB to a PHY layer.

### BACKGROUND OF THE INVENTION

### Field of the Invention

The present disclosure generally relates to wireless communication systems. More specifically, aspects of the present disclosure relate to a method and a device for speeding up packet processing via hardware acceleration.

### Description of the Related Art

In a wireless communications system, a link that goes in the direction from a terminal device to a radio access network is called an uplink, whereas a link that goes in the direction from a radio access network to a terminal device called is a downlink. The terminal device and the radio access device transmit various types of data in uplinks and downlinks, based on various protocol layers developed by the 3rd generation partnership project (3GPP) organization. Examples include control signaling or service data. These protocol layers include a physical (PHY) layer, a media access control (MAC) layer, a radio link control (RLC) layer, a packet data convergence protocol (PDCP) layer, and others.

In some cases, a wireless communications system may utilize these protocol layers to process downlink data transmissions. For example, the wireless communications system may be based on functions divided into a PDCP layer (e.g., for header compression and sequencing), an RLC layer (e.g., for error correction and segmentation/concatenation of packets), and a MAC layer (e.g., for multiplexing and error correction).

However, layer 2 (e.g., MAC, RLC and PDCP layers) processes are implemented by software in a central processing unit (CPU) by accessing the memory. These processes are performed by the software of the CPU, and it is typically computation intensive, requiring a significant amount of processing overhead. Therefore, there is a need for improved devices and methods for speeding up packet processing to solve this problem.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

Therefore, the main purpose of the present disclosure is to provide devices and methods for speeding up packet processing improve data/packet process time and lower overall power consumption.

In an exemplary embodiment, a method for speeding up packet processing is provided. The method is implemented by a hardware acceleration circuitry of a computing device and comprises receiving an uplink grant configuration from a network. The method comprises performing a packet data convergence protocol (PDCP) process on PDCP service data units (SDUs) corresponding to uplink packets from an upper layer to obtain PDCP protocol data units (PDUs). The method comprises performing a radio link control (RLC) process on RLC SDUs corresponding to the PDCP PDUs to obtain RLC PDUs. The method comprises performing a medium access control (MAC) process on MAC SDUs corresponding to the RLC PDUs to obtain a transport blocks (TB). The method comprises transmitting the TB to a physical (PHY) layer.

In some embodiments, the PDCP process, the RLC process, and the MAC process are performed completely based on hardware without memory access.

In some embodiments, the PDCP process comprises: assembling the PDCP SDUs into the PDCP PDUs, wherein each PDCP PDU includes a PDCP payload; and transmitting the PDCP PDUs; wherein the PDCP PDU further includes a PDCP header when the PDCP payload is a complete PDCP SDU, a first segment of a PDCP SDU or a middle segment of the PDCP SDU; and wherein the PDCP PDU does not include a PDCP header when the PDCP payload is a last segment of the PDCP SDU.

In some embodiments, the PDCP process further comprises: encrypting the PDCP payload when the PDCP payload is a complete PDCP SDU, a first segment of a PDCP SDU or a middle segment of the PDCP SDU.

In some embodiments, the RLC process comprises: assembling the RLC SDUs into the RLC PDUs; and transmitting the RLC PDUs; wherein each RLC PDU includes an RLC header and an RLC payload, and the RLC payload is used to carry one or more RLC SDUs or a segment of a PDCP SDU.

In some embodiments, the MAC process comprises: assembling the MAC SDUs into MAC PDUs; and multiplexing the MAC PDUs into the TB; wherein each MAC PDU includes a MAC header and a MAC payload, and the MAC payload is used to carry one MAC SDU.

In some embodiments, the uplink packets are Internet protocol (IP) packets.

In an exemplary embodiment, a device for speeding up packet processing is provided. The device comprises a central processing unit (CPU) and a hardware acceleration processor coupled to the CPU. The hardware acceleration processor is operable to: receive an uplink grant configuration from a network; perform a packet data convergence protocol (PDCP) process on PDCP service data units (SDUs) corresponding to uplink packets from an upper layer to obtain PDCP protocol data units (PDUs); perform a radio link control (RLC) process on RLC SDUs corresponding to the PDCP PDUs to obtain RLC PDUs; perform a medium access control (MAC) process on MAC SDUs corresponding to the RLC PDUs to obtain a transport blocks (TB); and transmit the TB to a physical (PHY) layer.

### BRIEF DESCRIPTION OF THE DRAWINGS

The accompanying drawings are included to provide a further understanding of the present disclosure, and are incorporated in and constitute a part of the present disclosure. The drawings illustrate implementations of the disclosure and, together with the description, serve to explain the principles of the disclosure. It should be appreciated that the drawings are not necessarily to scale as some components may be shown out of proportion to their size in actual implementation in order to clearly illustrate the concept of the present disclosure.

FIG. 1 illustrates an example of a wireless communications system for speeding up packet processing in accordance with various aspects of the present disclosure.

FIG. 2 is a conceptual diagram illustrating an example of the radio protocol architecture for the user and control planes.

FIG. 3 is a conceptual diagram illustrating an example of upper data packets being processed through the L2 layer.

FIG. 4 is an example data path architecture for a computing device capable of speeding up packet processing according to an embodiment of the present disclosure.

FIGS. 5A˜5B are schematic diagrams of the PDCP acceleration circuitry performing the PDCP process, the RLC acceleration circuitry performing the RLC process and the MAC acceleration circuitry performing the MAC process according to the embodiment of the present disclosure with reference to the schematic diagrams shown in FIG. 4.

FIG. 6 is a flow chart illustrating the method for speeding up packet processing according to an embodiment of the disclosure with reference to the schematic diagrams shown in FIGS. 4 and 5A˜5B.

### DETAILED DESCRIPTION OF THE INVENTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using number of the aspects set forth herein. In addition, the scope of the disclosure is intended to cover such an apparatus or method which is practiced using another structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects. Furthermore, like numerals refer to like elements throughout the several views, and the articles “a” and “the” includes plural references, unless otherwise specified in the description.

It should be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion. (e.g., “between” versus “directly between”, “adjacent” versus “directly adjacent”, etc.).

The embodiments of the present disclosure provide a method and device for implementing hardware acceleration in order to resolve a problem that central processing unit (CPU) and memory resources are occupied and consumed when the processes are performed in the PDCP layer, the RLC layer and the MAC layer.

In computing, hardware acceleration generally involves using hardware circuits to perform functions more quickly and efficiently than executing software on general purpose processors.

A hardware acceleration device usually may usually be implemented by a hardware acceleration function module integrated in a CPU or a network adapter. A hardware acceleration device is usually accessed and used by an application program of a computer device. When the application program of the computer device requires the hardware acceleration device to perform acceleration processing in a service processing process, an instruction related to hardware acceleration is executed using the CPU. The CPU sends data/packets on which hardware acceleration processing needs to be performed to the hardware acceleration device using an interface provided by the hardware acceleration device, and receives data/packets that is obtained after acceleration processing and that is returned by the hardware acceleration device. The application program processes a service using the CPU. In practical application, various application programs call different hardware acceleration devices by executing different tasks, to implement the hardware acceleration processing. Therefore, for clear description of technical solutions provided in the embodiments of the present disclosure, in the embodiments of the present disclosure, a process in which the various application programs implement hardware acceleration processing using a CPU is described using an example in which the CPU initiates a hardware acceleration request and receives data/packets obtained after the hardware acceleration processing.

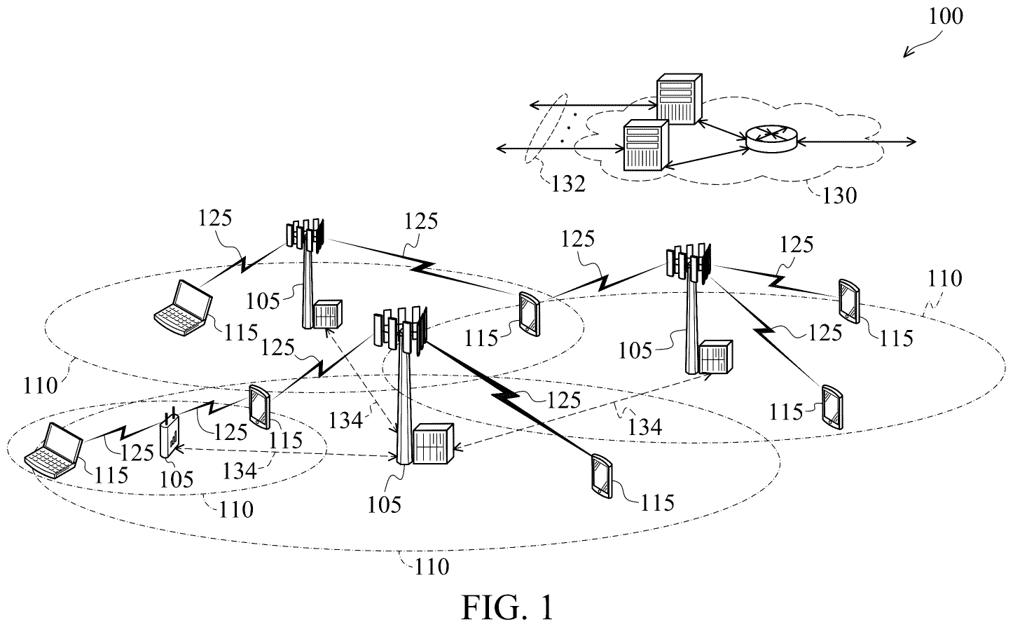

FIG. 1 illustrates an example of a wireless communications system 100 for speeding up packet processing in accordance with various aspects of the present disclosure. The wireless communications system 100 includes base stations 105, user equipment (UEs) 115, and a core network 130. In some examples, the wireless communications system 100 may be a cellular network (for example, LTE, 3G, 4G, 5G, 6G) and a wireless network (for example, Wi-Fi).

The base stations 105 may wirelessly communicate with the UEs 115 via one or more base station antennas. Each base station 105 may provide communication coverage for a respective geographic coverage area 110. Communication links 125 shown in wireless communications system 100 may include uplink (UL) transmissions from a UE 115 to a base station 105, or downlink (DL) transmissions, from a base station 105 to a UE 115. The UEs 115 may be dispersed throughout the wireless communications system 100, and each UE 115 may be stationary or mobile. A UE 115 may also be referred to as a mobile station, a subscriber station, a remote unit, a wireless device, an access terminal, a handset, a user agent, a client, or some other suitable terminology. A UE 115 may also be a cellular phone, a wireless modem, a handheld device, a personal computer, a tablet, a personal electronic device, a machine type communication (MTC) device or the like.

The base stations 105 may communicate with the core network 130 and with one another. For example, base stations 105 may interface with the core network 130 through backhaul links 132 (e.g., S1, etc.). The base stations 105 may communicate with one another over backhaul links 134 (e.g., X2, etc.) either directly or indirectly (e.g., through core network 130). The base stations 105 may perform radio configuration and scheduling for communication with the UEs 115, or may operate under the control of a base station controller (not shown). In some examples, the base stations 105 may be macro cells, small cells, hot spots, or the like. The base stations 105 may also be referred to as eNodeBs (eNBs) 105.

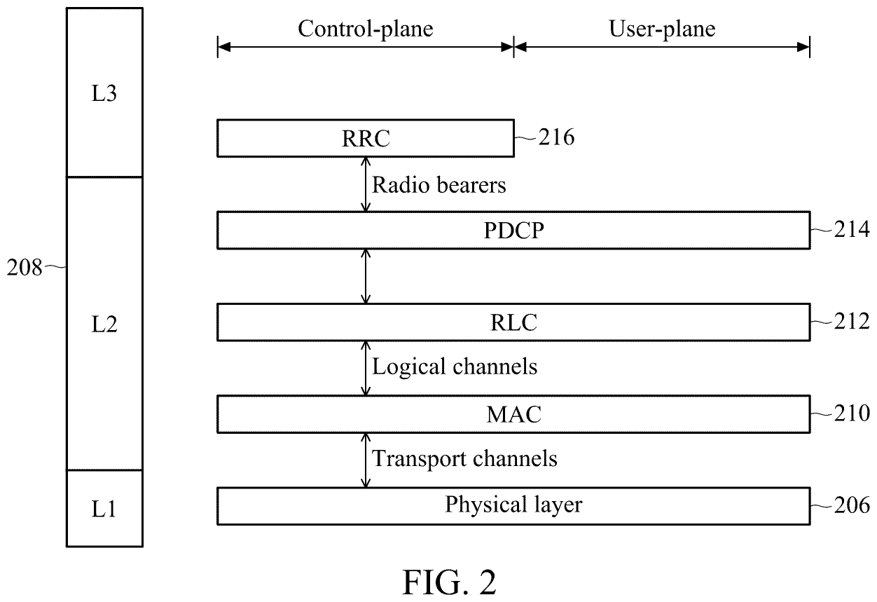

The radio protocol architecture may take on various forms depending on the particular application. An example for the wireless communications system 100 will now be presented with reference to FIG. 2. FIG. 2 is a conceptual diagram illustrating an example of the radio protocol architecture for the user and control planes.

Turning to FIG. 2, the radio protocol architecture for the UE and the base station is shown with three layers: Layer 1, Layer 2, and Layer 3. Layer 1 implements various physical layer signal processing functions. Layer 1 will be referred to herein as the physical layer 206. Layer 2 (L2 layer) 208 is above the physical layer 206 and is responsible for the link between the UE and the base station over the physical layer 206.

In the user plane, the L2 layer 208 includes a media access control (MAC) layer 210, a radio link control (RLC) layer 212, and a packet data convergence protocol (PDCP) 214 layer, which are terminated at the base station on the network side. Although not shown, the UE may have several upper layers above the L2 layer 208 including a network or IP layer and an application layer.

The PDCP layer 214 provides multiplexing between different radio bearers and logical channels. The PDCP layer 214 also provides header compression for upper layer data packets to reduce radio transmission overhead, security by ciphering the data packets, and handover support for UEs between base stations. The RLC layer 212 provides segmentation and reassembly of upper layer data packets, retransmission of lost data packets, and reordering of data packets to compensate for out-of-order reception due to Hybrid Automatic Repeat reQuest (HARQ). The MAC layer 210 provides multiplexing between logical and transport channels. The MAC layer 210 is also responsible for allocating the various radio resources in one cell among the UEs. The MAC layer 210 is also responsible for HARQ operations.

In the control plane, the radio protocol architecture for the UE and the base station is substantially the same for the physical layer 206 and the L2 layer 208 with the exception that there is no header compression function for the control plane. The control plane also includes a radio resource control (RRC) layer 216 in Layer 3. The RRC layer 216 is responsible for obtaining radio resources (i.e., radio bearers) and for configuring the lower layers using RRC signaling between the base station and the UE.

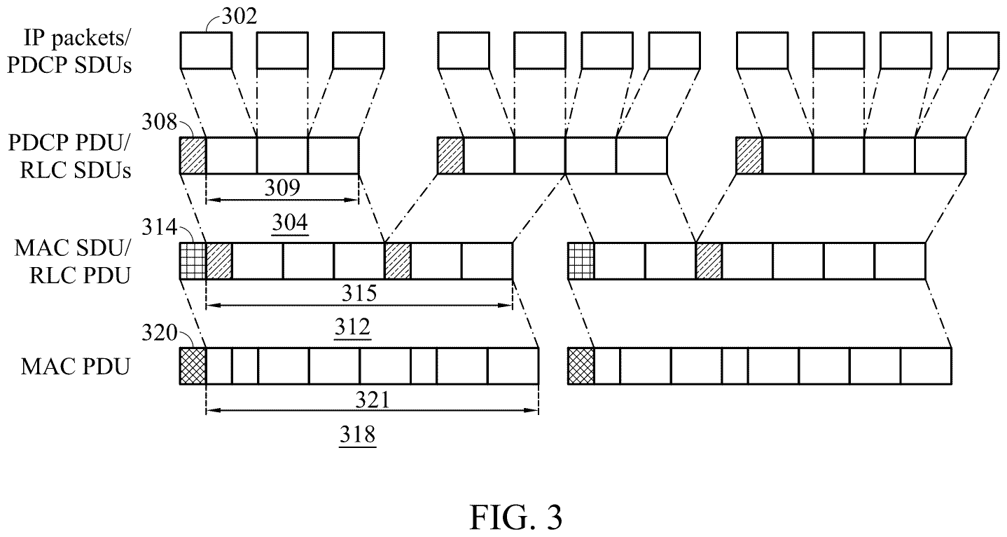

FIG. 3 is a conceptual diagram illustrating an example of upper data packets being processed through the L2 layer. The term “processed” is intended to include both (1) the generation of MAC protocol data units (PDUs) from upper layer data packets (e.g., IP packets) on the transmit side, and (2) the recovery of upper layer data packets from MAC PDUs on the receive side. As a matter of convention, on the transmit side, a layer in the protocol stack receives service data units (SDUs) from an upper layer and processes the SDUs to produce PDUs for delivery to a lower layer. On the receive side, a layer in a protocol stack receives PDUs from a lower layer and processes the PDUs to recover SDUs for delivery to an upper.

When the apparatus (e.g., eNodeB or UE) is in a transmission mode, upper layer packets may be provided to the PDCP layer in a form of PDCP SDUs 302. An IP packet pool is used for buffering packet transmission from the upper layer. The PDCP sublayer assembles the PDCP SDUs 302 into PDCP PDUs 304. Each PDCP PDU 304 includes a PDCP header 308 and a PDCP payload 309. The PDCP payload 309 may be used to carry PDCP SDUs 302. In this example, the PDCP payload 309 for each PDCP PDU 304 includes three PDCP SDUs 302. The PDCP PDUs 304 may then be provided to the RLC sublayer.

At the RLC layer, the PDCP PDUs 304, or RLC SDUs, are assembled into RLC PDUs 312. Each RLC PDU 312 includes an RLC header 314 and an RLC payload 315. The RLC payload 315 may be used to carry RLC SDUs 304. In this example, the RLC SDUs 310 may be fragmented to enable three RLC SDUs 304 to be assembled into the payloads 315 for two PLC PDUs 312. The RLC PDUs 312 may then be provided to the MAC layer.

At the MAC layer, the RLC PDUs 312, or MAC SDUs, are assembled into MAC PDUs 318. Each MAC PDU 318 includes a MAC header 320 and a MAC payload 321. The MAC payload 321 may be used to carry RLC SDUs 304. In this example, the MAC payload 321 for each MAC PDU 318 includes one MAC SDU 312. The MAC PDUs 318 may then be provided to the physical layer (not shown).

When the apparatus is in the receiving mode, the process described above is reversed.

In 3GPP protocol stack, each layer of the protocol stack in cellular networks has specific operations that contribute to time consumption and may involve memory access delays.

The PDCP layer involves time-consuming operations such as complicated algorithm calculations in ROHC (Robust Header Compression), integrity protection, and cipher operations. In traditional, these operations may be performed via software with memory crossing. Additionally, these operations may require substantial memory resources for storing processed data and intermediate results, potentially leading to memory crossing delays.

In the RLC layer, when the RLC software receives transmission (TX) grant information from the MAC software, it retrieves PDCP PDUs from the PDCP PDU pool and processes them to generate RLC PDUs. The time consumption operation in the RLC layer involves the segmentation or concatenation of RLC SDUs to align with the size requirements of RLC PDUs in the uplink (UL) path via software with memory crossing. Furthermore, these operations may necessitate additional memory for storing segmented or concatenated data, contributing to potential delays in data processing due to memory access.

Within the MAC layer, the operations involve the multiplexing of MAC SDUs to compose MAC PDUs. The MAC software composes the transport block (TB) with the received RLC PDUs via memory and outputs it to the physical layer (PHY). The multiplexing process within the MAC layer may introduce time consumption as the MAC software organizes and formats the MAC PDUs from the incoming MAC SDUs. Memory resources may also be impacted as the MAC layer manages the multiplexed data and the composed transmission block, potentially leading to memory access delays.

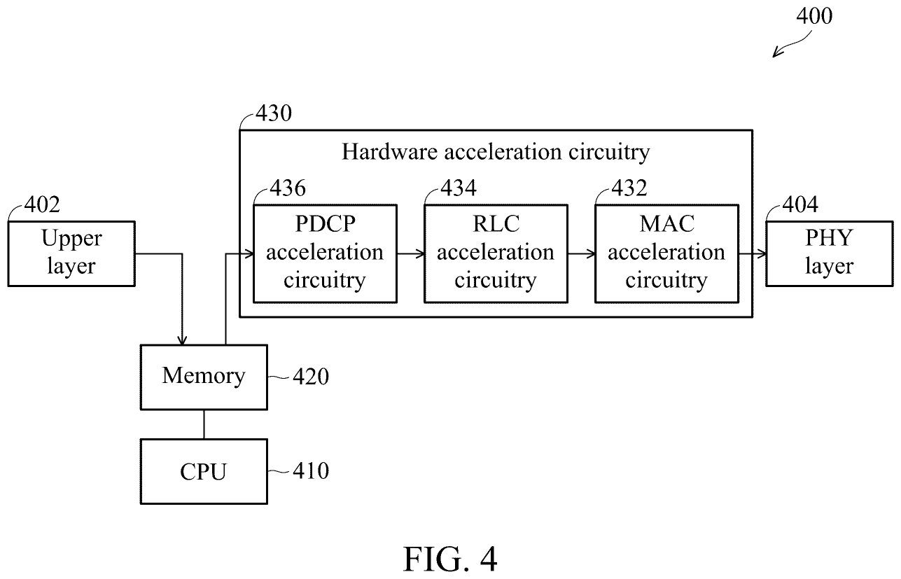

FIG. 4 is an example data path architecture 400 for a computing device capable of speeding up packet processing according to an embodiment of the present disclosure.

As shown in FIG. 4, a computing device may at least include a CPU 410, a memory 420 and a hardware acceleration circuitry 430. The CPU 410 and the hardware acceleration circuitry 430 are connected to the memory 420.

It should be noted that, in FIG. 4, the hardware acceleration circuitry 430 may be implemented using the foregoing hardware acceleration device or may be implemented using another device or module with a hardware acceleration function. In addition, FIG. 4 is only an example for illustrating a structure and composition of a computer device. In further implementation, the computing device may further include another component, such as a hard disk or a graphics card. This embodiment of the present disclosure constitutes no limitation on other composition and structure further included by the computing device in further implementation.

The hardware acceleration circuitry 430 may comprise a MAC acceleration circuitry 432, an RLC acceleration circuitry 434 and a PDCP acceleration circuitry 436.

When the PDCP acceleration circuitry 436 receives uplink packets from an upper layer 402, the PDCP acceleration circuitry 436 may perform a PDCP process on PDCP service data units (SDUs) corresponding to the uplink packets to obtain PDCP protocol data units (PDUs), wherein the uplink packets are Internet protocol (IP) packets. Specifically, the PDCP process performed by the PDCP acceleration circuitry 436 comprises the following steps: the PDCP acceleration circuitry 436 may assemble the PDCP SDUs into the PDCP PDUs and transmits the PDCP PDUs to the RLC acceleration circuitry 434, wherein each PDCP PDU includes a PDCP payload. In one embodiment, the PDCP PDU may further include a PDCP header when the PDCP payload is a complete PDCP SDU, a first segment of a PDCP SDU or a middle segment of the PDCP SDU. In another embodiment, the PDCP PDU does not include a PDCP header when the PDCP payload is the last segment of the PDCP SDU. In addition, the PDCP acceleration circuitry 436 may encrypt the PDCP payload when the PDCP payload is a complete PDCP SDU, a first segment of a PDCP SDU or a middle segment of the PDCP SDU.

Then, the RLC acceleration circuitry 434 performs an RLC process on RLC SDUs corresponding to the PDCP PDUs to obtain RLC PDUs. Specifically, the RLC process performed by the RLC acceleration circuitry 434 comprises the following steps: the RLC acceleration circuitry 434 assembles the RLC SDUs into the RLC PDUs and transmits the RLC PDUs to the MAC acceleration circuitry 432, wherein each RLC PDU includes an RLC header and an RLC payload, and the RLC payload is used to carry one or more RLC SDUs or a segment of a PDCP SDU.

The MAC acceleration circuitry 432 performs a MAC process on MAC SDUs corresponding to the RLC PDUs to obtain a transport block (TB) and transmits the TB to a physical (PHY) layer 404. Specifically, the MAC process performed by the MAC acceleration circuitry 432 comprises the following steps: the MAC acceleration circuitry 432 assembles the MAC SDUs into MAC PDUs and multiplexes the MAC PDUs into the TB, wherein each MAC PDU includes a MAC header and a MAC payload, and the MAC payload is used to carry one MAC SDU.

In FIG. 4, the MAC process, the RLC process and the PDCP process are performed completely based on hardware without memory access. In addition, even though the PDCP acceleration circuitry 436, the RLC acceleration circuitry 434 and the MAC acceleration circuitry 432 are described herein as utilized in the context of the computing device in FIG. 4, in other implementations, embodiments of the PDCP acceleration circuitry 436, the RLC acceleration circuitry 434, and the MAC acceleration circuitry 432 can also be used in a standalone server, desktop computer, laptop computer, or other suitable types of computing device.

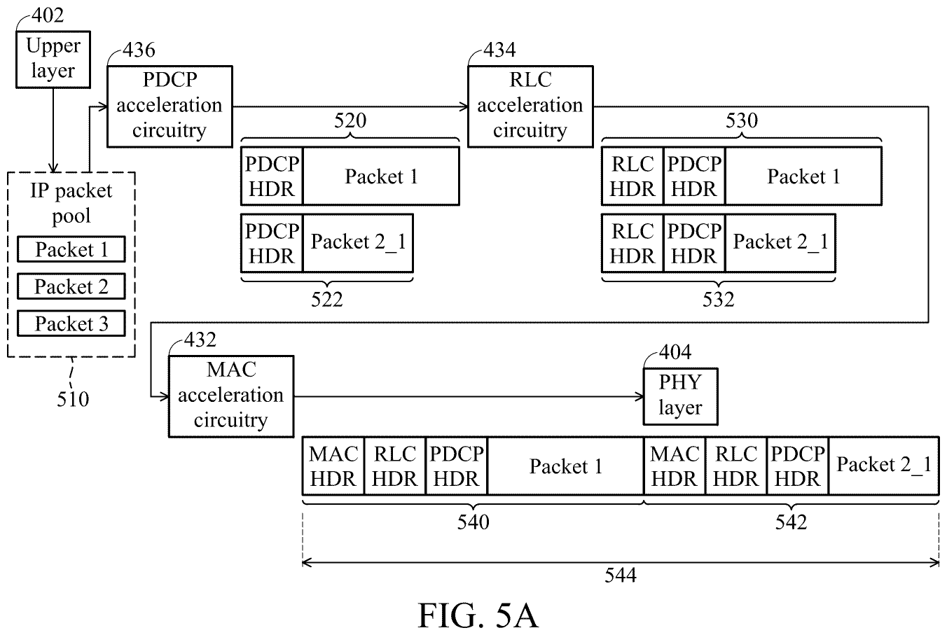

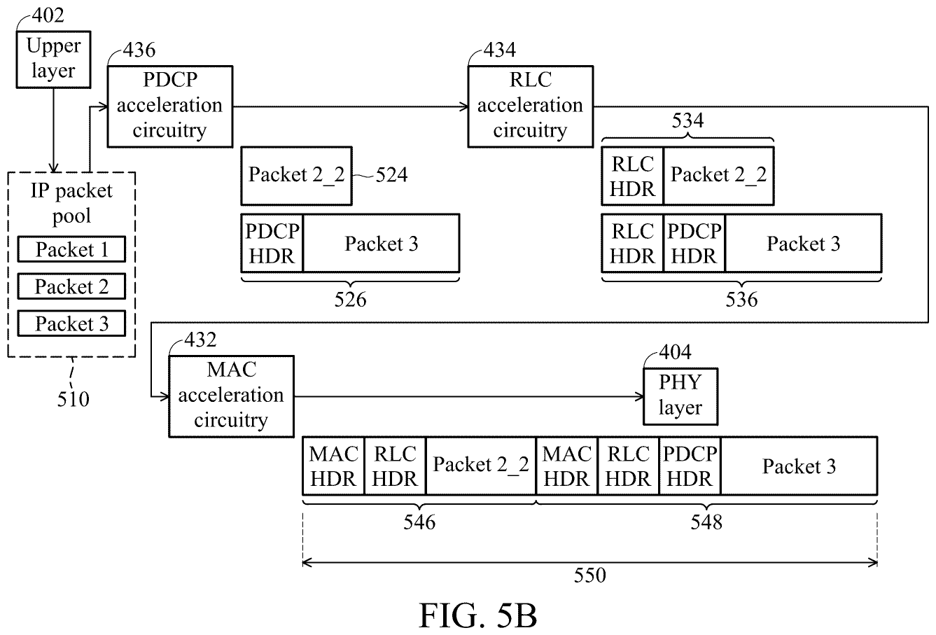

FIGS. 5A˜5B are schematic diagrams of the PDCP acceleration circuitry performing the PDCP process, the RLC acceleration circuitry performing the RLC process and the MAC acceleration circuitry performing the MAC process according to the embodiment of the present disclosure with reference to the schematic diagrams shown in FIG. 4.

As shown in FIG. 5A, the uplink packets 1˜3 from the upper layer 402 may be buffered in an IP packet pool 510 in the memory. The PDCP acceleration circuitry 436 obtains the packets 1˜2 from the IP packet pool 510, segments the packet 2 into two smaller packet segments 2_1 and 2_2, and assembles the packet 1 and the packet segment 2_1 as PDCP SDUs into the PDCP PDUs 520 and 522. In one embodiment, the PDCP acceleration circuitry 436 may further encrypt the packet 1 and the packet segment 2_1, and attach PDCP headers to the packet 1 and the packet segment 2_1, respectively, to generate the PDCP PDUs 520 and 522. Then, the PDCP acceleration circuitry 436 transmits the PDCP PDUs 520 and 522 to the RLC acceleration circuitry 434.

When the RLC acceleration circuitry 434 receives the PDCP PDUs 520 and 522, the RLC acceleration circuitry 434 may assemble the PDCP PDUs 520 and 522 as the RLC SDUs into the RLC PDUs 530 and 532 by attaching the RLC headers, and transmits the RLC PDUs 530 and 532 to the MAC acceleration circuitry 432.

When the MAC acceleration circuitry 432 receives the RLC PDUs 530 and 532, the MAC acceleration circuitry 432 may assemble the RLC PDUs 530 and 532 as the MAC SDUs into the MAC PDUs 540 and 542 by attaching the MAC headers, multiplex the MAC PDUs 540 and 542 into the TB 544 and transmit the TB 544 to the PHY layer 404.

Upon receiving an UL grant configuration, based on the UL grant configuration and the data to be transmitted, the UE prepares the appropriate number of data packets which may vary based on the granted resources and transmission parameters. Additionally, the UE determines the RLC segment type for the prepared packets. This decision may involve selecting the appropriate segmentation method based on the size of the user data and the protocol requirements, ensuring that the data is efficiently organized for transmission. Once the data packets and the RLC segment type are determined, the UE triggers the hardware (HW) to perform the encryption (cipher) operation on the fly. The cipher on the fly operation involves the encryption of user data packets in real-time (on-the-fly) upon receiving the UL grant configuration, The encryption is performed in a continuous and seamless manner, allowing for efficient data protection without the need for pre-encryption or temporary storage. There is no more DRAM crossing when packets enter PDCP HW to the PHY layer. The segment RLC PDU is only encrypted part of packet 2. It can reduce execution time for this TTI (Transfer Time Interval) because the HW has no need to encrypt whole packet 2.

In FIG. 5B, the PDCP acceleration circuitry 436, the RLC acceleration circuitry 434 and the MAC acceleration circuitry 432 then processes the remaining packet segment 2_2 and the remaining packet 3 in the IP packet pool 510.

The PDCP acceleration circuitry 436 obtains the remaining packet segment 2_2 and the remaining packet 3 from the IP packet pool 510, and assembles the packet segment 2_2 and the remaining packet 3 as PDCP SDUs into the PDCP PDUs 524 and 526. It should be noted that the PDCP acceleration circuitry 436 only encrypts the packet 3, and attach a PDCP header to the packet 3 to generate the PDCP PDU 536. The PDCP acceleration circuitry 436 does not encrypt the packet segment 2_2 nor attach a PDCP header to the packet segment 2_2. In other words, since the PDCP acceleration circuitry 436 only encrypts part of the packet 2, it can reduce the execution time of this transmission time interval (TTI). Then, the PDCP acceleration circuitry 436 transmits the PDCP PDUs 524 and 526 to the RLC acceleration circuitry 434.

When the RLC acceleration circuitry 434 receives the PDCP PDUs 524 and 526, the RLC acceleration circuitry 434 may assemble the PDCP PDUs 524 and 526 as the RLC SDUs into the RLC PDUs 534 and 536 by attaching the RLC headers, and transmits the RLC PDUs 534 and 536 to the MAC acceleration circuitry 432.

When the MAC acceleration circuitry 432 receives the RLC PDUs 534 and 536, the MAC acceleration circuitry 432 may assemble the RLC PDUs 534 and 536 as the MAC SDUs into the MAC PDUs 546 and 548 by attaching the MAC headers, multiplex the MAC PDUs 546 and 548 into the TB 550 and transmit the TB 550 to the PHY layer 404.

It should be noted that the number of the segments of the packet 2 in FIGS. 5A˜5B is not used to limit the present disclosure, and those skilled in the art can make appropriate replacements or adjustments according to this embodiment.

The PDCP HW is capable of encrypting packet 2 from the middle of the packet, without the need to encrypt the entire packet to obtain the encrypted packet 2_2. This approach allows for a more efficient encryption process, as encryption can commence from the middle of the packet, reducing processing requirements and enhancing encryption speed. By encrypting only the necessary portion of the packet, the overall processing overhead is minimized, leading to a more streamlined and efficient encryption operation. The encryption of packets occurs when the packets are being composed into the transport block (TB) for transmission. This strategy results in a better loading balance in the cipher engine, as only the transmission (TX) data size needs to be encrypted in every Transmission Time Interval (TTI). By performing encryption at the point of composition into the TB, the hardware (HW) used for encryption is not adversely affected by peak input from upper layers, ensuring consistent and optimized performance during data transmission.

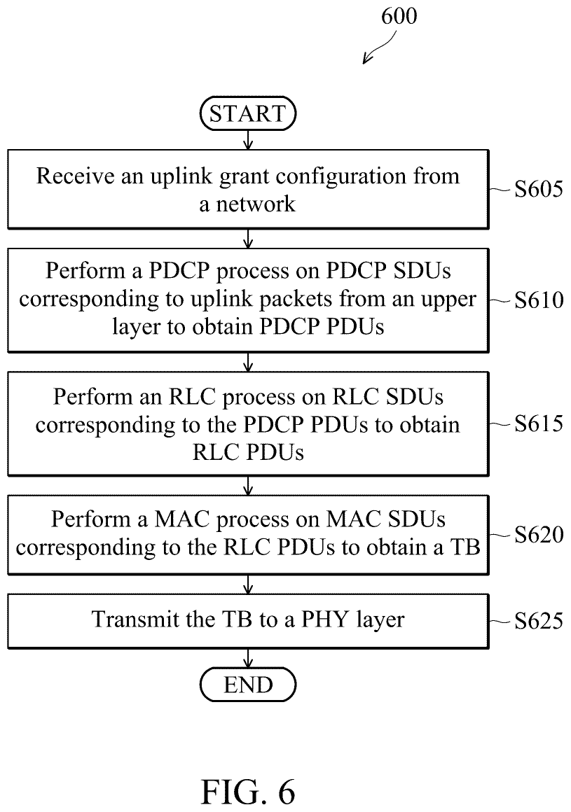

FIG. 6 is a flow chart 600 illustrating the method for speeding up packet processing according to an embodiment of the disclosure with reference to the schematic diagrams shown in FIGS. 4 and 5A˜5B.

In step S605, the hardware acceleration circuitry receives an uplink grant configuration from a network.

Then, in step S610, the hardware acceleration circuitry performs a packet data convergence protocol (PDCP) process on PDCP service data units (SDUs) corresponding to uplink packets from an upper layer to obtain PDCP protocol data units (PDUs). In this embodiment, the PDCP process comprises assembling the PDCP SDUs into the PDCP PDUs, wherein each PDCP PDU includes a PDCP payload; and transmitting the PDCP PDUs. In one embodiment, the PDCP PDU further includes a PDCP header when the PDCP payload is a complete PDCP SDU, a first segment of a PDCP SDU or a middle segment of the PDCP SDU; the PDCP PDU does not include a PDCP header when the PDCP payload is the last segment of the PDCP SDU. In another embodiment, the hardware acceleration circuitry further encrypts the PDCP payload when the PDCP payload is a complete PDCP SDU, a first segment of a PDCP SDU or a middle segment of the PDCP SDU.

In step S615, the hardware acceleration circuitry performs an RLC process on RLC SDUs corresponding to the PDCP PDUs to obtain RLC PDUs. In one embodiment, the RLC process comprises assembling the RLC SDUs into the RLC PDUs; and transmitting the RLC PDUs. In another embodiment, each RLC PDU includes an RLC header and an RLC payload, and the RLC payload is used to carry one or more RLC SDUs or a segment of a PDCP SDU.

Next, in step S620, the hardware acceleration circuitry performs a MAC process on MAC SDUs corresponding to the RLC PDUs to obtain a TB. In one embodiment, the MAC process comprises assembling the MAC SDUs into MAC PDUs; and multiplexing the MAC PDUs into the TB, wherein each MAC PDU includes a MAC header and a MAC payload, and the MAC payload is used to carry one MAC SDU.

In step S625, the hardware acceleration circuitry transmits the TB to a PHY layer.

In another embodiment, the PDCP process in step S610, the RLC process in step S615 and the MAC process in step S620 are performed completely based on hardware without memory access.

In the method and device for speeding up packet processing provided in the embodiments of the present disclosure, the hardware acceleration circuitry replaces software to perform the PDCP process, the RLC process and the MAC process in layer 2 for speeding up the process time and then transfers the packet to the PHY layer directly without any memory crossing. In this way, the method and device for speeding up packet processing can be helpful for overall power consumption optimization and memory footprint reduction.

A person of ordinary skill in the art may be aware that, the units and steps in the examples described with reference to the embodiments disclosed herein may be implemented by electronic hardware, computer software, or a combination thereof. To clearly describe the interchangeability between the hardware and the software, the foregoing has usually described compositions and steps of each example according to functions. Whether the functions are performed by hardware or software depends on particular applications and design constraint conditions of the technical solutions. A person skilled in the art may use different methods to implement the described functions for each particular application, but it should not be considered that the implementation goes beyond the scope of the present disclosure.

It may be clearly understood by a person skilled in the art that, for the purpose of convenient and brief description, for a detailed working process of the foregoing device and unit, reference may be made to a corresponding process in the foregoing method embodiments, and details are not described herein.

In the several embodiments provided in this application, it should be understood that the disclosed device and method may be implemented in other manners. For example, the described device embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces, indirect couplings or communication connections between the apparatuses or units, or electrical connections, mechanical connections, or connections in other forms.

The units described as separate parts may or may not be physically separate, and parts displayed as units may or may not be physical units, may be located in one position, or may be distributed on a plurality of network units. A part or all of the units may be selected according to actual needs to achieve the objectives of the solutions of the embodiments of the present disclosure.

In addition, functional units in the embodiments of the present disclosure may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present disclosure essentially, or the part contributing to the other approaches, or all or a part of the technical solutions may be implemented in the form of a software product. The software product is stored in a storage medium and includes several instructions for instructing a computer device (which may be a personal computer, a server, or a network device) to perform all or a part of the steps of the methods described in the embodiments of the present disclosure. The foregoing storage medium includes any medium that can store program code, such as a universal serial bus (USB) flash drive, a removable hard disk, a read-only memory (ROM), a random access memory (RAM), a magnetic disk, or an optical disc.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for speeding up packet processing, wherein the method is implemented by a hardware acceleration circuitry of a computing device, comprising:
receiving an uplink grant configuration from a network;
performing a packet data convergence protocol (PDCP) process on PDCP service data units (SDUs) corresponding to uplink packets from an upper layer to obtain PDCP protocol data units (PDUs);
performing a radio link control (RLC) process on RLC SDUs corresponding to the PDCP PDUs to obtain RLC PDUs;
performing a medium access control (MAC) process on MAC SDUs corresponding to the RLC PDUs to obtain a transport blocks (TB); and
transmitting the TB to a physical (PHY) layer.

2. The method for speeding up packet processing as claimed in claim 1, wherein the PDCP process, the RLC process, and the MAC process are performed completely based on hardware without memory access.

3. The method for speeding up packet processing as claimed in claim 1, wherein the PDCP process comprises:
assembling the PDCP SDUs into the PDCP PDUs, wherein each PDCP PDU includes a PDCP payload; and
transmitting the PDCP PDUs;
wherein the PDCP PDU further includes a PDCP header when the PDCP payload is a complete PDCP SDU, a first segment of a PDCP SDU or a middle segment of the PDCP SDU; and
wherein the PDCP PDU does not include a PDCP header when the PDCP payload is a last segment of the PDCP SDU.

4. The method for speeding up packet processing as claimed in claim 3, wherein the PDCP process further comprises:
encrypting the PDCP payload when the PDCP payload is a complete PDCP SDU, a first segment of a PDCP SDU or a middle segment of the PDCP SDU.

5. The method for speeding up packet processing as claimed in claim 1, wherein the RLC process comprises:
assembling the RLC SDUs into the RLC PDUs; and
transmitting the RLC PDUs;
wherein each RLC PDU includes an RLC header and an RLC payload, and the RLC payload is used to carry one or more RLC SDUs or a segment of a PDCP SDU.

6. The method for speeding up packet processing as claimed in claim 1, wherein the MAC process comprises:
assembling the MAC SDUs into MAC PDUs; and
multiplexing the MAC PDUs into the TB;
wherein each MAC PDU includes a MAC header and a MAC payload, and the MAC payload is used to carry one MAC SDU.

7. The method for speeding up packet processing as claimed in claim 1, wherein the uplink packets are Internet protocol (IP) packets.

8. A device for speeding up packet processing, comprising:
a central processing unit (CPU); and
a hardware acceleration processor coupled to the CPU, wherein the hardware acceleration processor is operable to:
receive an uplink grant configuration from a network;
perform a packet data convergence protocol (PDCP) process on PDCP service data units (SDUs) corresponding to uplink packets from an upper layer to obtain PDCP protocol data units (PDUs);
perform a radio link control (RLC) process on RLC SDUs corresponding to the PDCP PDUs to obtain RLC PDUs;
perform a medium access control (MAC) process on MAC SDUs corresponding to the RLC PDUs to obtain a transport blocks (TB); and
transmit the TB to a physical (PHY) layer.

9. The device for speeding up packet processing as claimed in claim 8, wherein the PDCP process, the RLC process, and the MAC process are performed completely based on hardware without memory access.

10. The device for speeding up packet processing as claimed in claim 8, wherein the PDCP process comprises:
assembling the PDCP SDUs into the PDCP PDUs, wherein each PDCP PDU includes a PDCP payload; and
transmitting the PDCP PDUs;
wherein the PDCP PDU further includes a PDCP header when the PDCP payload is a complete PDCP SDU, a first segment of a PDCP SDU or a middle segment of the PDCP SDU; and
wherein the PDCP PDU does not include a PDCP header when the PDCP payload is a last segment of the PDCP SDU.

11. The device for speeding up packet processing as claimed in claim 10, wherein the PDCP process further comprises:
encrypting the PDCP payload when the PDCP payload is a complete PDCP SDU, a first segment of a PDCP SDU or a middle segment of the PDCP SDU.

12. The device for speeding up packet processing as claimed in claim 8, wherein the RLC process comprises:
assembling the RLC SDUs into the RLC PDUs; and
transmitting the RLC PDUs;
wherein each RLC PDU includes an RLC header and an RLC payload, and the RLC payload is used to carry one or more RLC SDUs or a segment of a PDCP SDU.

13. The device for speeding up packet processing as claimed in claim 8, wherein the MAC process comprises:
assembling the MAC SDUs into MAC PDUs; and
multiplexing the MAC PDUs into the TB;
wherein each MAC PDU includes a MAC header and a MAC payload, and the MAC payload is used to carry one MAC SDU.

14. The device for speeding up packet processing as claimed in claim 8, wherein the uplink packets are Internet protocol (IP) packets.
